(19) United States
(12) Patent Application Publication
(10) Pub. No.: US 2008/0299405 A1
(43) Pub. Date: Dec. 4, 2008

(54) AQUEOUS COATING COMPOSITIONS

(75) Inventors: Yan Wang, Shanghai (CN); Yan Yan Zhang, Shanghai (CN); Mitchell T. Johnson, Gig Harbor, WA (US); Andrew S. Waller, Stillwater, MN (US)

Correspondence Address: 3M INNOVATIVE PROPERTIES COMPANY, PO BOX 33427, ST. PAUL, MN, 55133-3427, US

(73) Assignee: 3M Innovative Company

(21) Appl. No.: 12/120,248

(22) Filed: May 14, 2008

(30) Foreign Application Priority Data
May 30, 2007 (CN) CN2007-10-109269.

(51) Int. Cl. B32B 27/30; C08K 5/05; C09D 5/14

(52) U.S. Cl. 428/500; 524/380; 523/122

(57) ABSTRACT

Aqueous coating compositions that contain two non-fluorinated and silicon-free hydrocarbon-based surfactants are provided. The hydrocarbon-based surfactants are alkylated acetylenic diols. These aqueous coating compositions are useful as floor finishes and polishes.

### CROSS REFERENCE TO RELATED APPLICATIONS

This application claims priority from Chinese Patent Application Serial No. 2007-10-109269.3, filed May 30, 2007.

### FIELD

The present disclosure relates to aqueous coating compositions. Such compositions are useful, for example, as floor finishes and polishes.

### BACKGROUND

Many commercially available aqueous coating compositions are useful as floor finishes and polishes, among other uses. These compositions typically contain emulsion-based polymer systems and combinations of additives such as organic solvents, surfactants, defoamers, leveling agents, plasticizers, coating aides, metal complexing agents, waxes and the like. Generally when used as a floor finish or polish the coating composition is spread on a surface and allowed to dry to form a film which forms a protective barrier against soil deposits. Surfaces coated in this way include for example floors, walls, furniture, windows, counter tops and bathroom surfaces.

Many of these aqueous coating compositions contain surfactants to reduce the surface tension of the coating composition and improve the wetting and leveling characteristics of the finish or polish. Fluorochemical surfactants are among the most popular wetting and leveling agents for these applications. It may be useful to develop aqueous coating compositions that use surfactants other than fluorochemical surfactants.

### SUMMARY

Aqueous coating compositions are provided that utilize hydrocarbon-based surfactants and yet provide desirable features characteristic of formulations using fluorochemical or silicon-containing surfactants such as silicone-based surfactants. Characteristics such as desirable wetting, leveling performance and high gloss are among the desirable features of these aqueous coating compositions.

In some embodiments the aqueous coating composition comprise a film-forming polymer and at least two non-fluorinated and silicon-free hydrocarbon-based surfactants. The hydrocarbon-based surfactants are both alkylated acetylenic diols. Additionally the aqueous coating composition may also contain one or more additives such as additional surfactants, polyvalent metal compounds, alkali soluble resins, waxes, permanent and fugitive plasticizers, defoamers, wetting agents, and biocides.

Also provided is a method for finishing a surface comprising the steps of applying to a surface an aqueous coating composition where the aqueous coating composition comprises a film-forming polymer and at least two non-fluorinated and silicon-free hydrocarbon-based surfactants. The application method may include the application of additional coats of the aqueous coating composition to form a multiple-layer coating.

Additionally, a finished surface comprising a surface and a coating on the surface is provided. The coating comprises an aqueous coating composition, the aqueous coating composition comprises a film-forming polymer and at least two non-fluorinated and silicon-free hydrocarbon-based surfactants, wherein the hydrocarbon-based surfactants are alkylated acetylenic diols. The coating may be dried. In some embodiments the coating comprises multiple layers of the aqueous coating composition.

Also provided is a method for preparing an aqueous coating composition. The aqueous coating composition includes a film-forming polymer to which at least two non-fluorinated and silicon-free hydrocarbon-based surfactants are added.

### DETAILED DESCRIPTION

Aqueous coating compositions that contain at least two non-fluorinated and silicon-free hydrocarbon-based surfactants are provided. These aqueous coating compositions are suitable for use as floor finishes and polishes, for example. The coating compositions typically contain a film-forming polymer and at least two non-fluorinated and silicon-free hydrocarbon-based surfactants. The compositions can be applied to a wide variety of substrates to form a protective barrier against soil deposits.

The terms “a”, “an”, and “the” are used interchangeably with “at least one” to mean one or more of the elements being described.

As used herein:

the term “aqueous coating composition” refers to compositions that are emulsions, suspensions or dispersions in water or a combination of water and water-miscible solvent(s) that can be coated on at least a portion of a substrate to form a protective coating on the substrate;

the term “surfactant” refers to a surface active agent capable of reducing the surface tension of an aqueous composition;

the term “non-fluorinated” with respect to surfactants refers to surfactants that contain no or essentially no fluorine atoms;

the term “silicon-free” with respect to surfactants refers to surfactants that contain no or essentially no silicon atoms;

the term “hydrocarbon-based” with respect to surfactants refers to surfactants that may contain carbon, hydrogen, oxygen, nitrogen and sulfur atoms and are free of fluorine atoms and silicon atoms;

the term “non-ionic” with respect to surfactants refers to surfactants that are free or essentially free of ionic groups; and

weight percentages are based upon the total weight of the composition including water unless otherwise noted.

The aqueous coating compositions contain at least one film-forming polymer. The film-forming polymers are generally emulsion polymers formed from ethylenically unsaturated monomers. The preparation of emulsion polymers is well known to those skilled in the art. Generally such emulsion polymers are prepared with ethylenically unsaturated monomers, initiators, surfactants or polymeric emulsifying agents and water.

The film-forming polymers are typically acrylic polymers, acrylic copolymers, styrene-acrylic copolymers, or blends thereof. Acrylic polymers contain only one type of acrylate monomer whereas the acrylic copolymers comprise two or more different types of acrylate monomers. Styrene-acrylic copolymers comprise at least one type of styrene monomer and one type of acrylate monomer. The acrylate monomers include for example acrylic acid, butyl acrylate, ethyl acrylate, methyl acrylate, 2-ethyl hexyl acrylate, acrylonitrile, acrylamide, methacrylic acid, methyl methacrylate, ethyl methacrylate, butyl methacrylate, methacrylamide, and the like. Styrene monomers include styrene, alpha-methyl styrene, and the like.

Acrylic polymers suitable as film-forming polymers include, for example, DURAPLUS 2 or DURAPLUS 3 modified acrylic floor polishes commercially available from Rohm and Haas Philadelphia, Pa. Other commercially available acrylic polymers or copolymers include MEGATRON 240, MEGATRON 228 or SYNTRAN 1921 from Interpolymer, Canton, Mass.

Examples of commercially available styrene-acrylic copolymers include, styrene/methyl methacrylate/butyl acrylate/methacrylic acid (S/MMA/BA/MAA) copolymers, styrene/methyl methacrylate/butyl acrylate/acrylic acid (S/MMA/BA/AA) copolymers, and the like, S/MMA/BA/MAA and S/MMA/BA/AA copolymers such as MOR-GLO-2 commercially available from OMNOVA Solutions, Inc. of Chester, S.C.

The aqueous coating composition typically contains between about 5 and 50 weight percent or even between about 10 and 35 weight percent film-forming polymers based on the weight of the aqueous coating composition.

Generally the aqueous coating compositions contain at least two non-fluorinated and silicon-free hydrocarbon-based surfactants that are alkylated acetylenic diols. In some embodiments the hydrocarbon-based surfactants are also non-ionic. In other embodiments the hydrocarbon-based surfactants may also be biodegradable.

A variety of alkylated acetylenic diols are commercially available. These surfactants are generally prepared from acetylenic diols. Examples of alkylated acetylenic diols include for example, those sold under the brand SURFYNOL wetting agents commercially available from Air Products and Chemicals, Allentown, Pa. Particularly useful wetting agents are SURFYNOL 504, and SURFYNOL 465.

In some embodiments the alkylated acetylenic diols are ethoxylated acetylenic diols such as DYNOL 604, commercially available from Air Products and Chemicals, Allentown, Pa.

The amount of hydrocarbon-based surfactant used in the aqueous coating composition may vary according the specific composition and desired use of the aqueous coating composition. In general, minimizing the amount of hydrocarbon-based surfactant is desirable for use in soil-resistant coatings. Typically, the combination of at least two hydrocarbon-based surfactants is present in a total amount less than about 1.5 weight %. In some embodiments, the hydrocarbon-based surfactants are present in amounts of 1.4 wt %, 1.2 wt % or less. In some embodiments, each hydrocarbon based surfactant is present in an amount of 0.5-0.1 wt %. Weight percentages are based upon the total weight of the composition including water.

The aqueous coating compositions can also contain other components such as polyvalent metal compounds, alkali soluble resins, waxes, permanent and fugitive plasticizers, defoamers, wetting agents, and biocides. Some embodiments may also contain particles. The polyvalent metal compound provides crosslinking of the film-forming polymers and increases the detergent resistance of the coating. Plasticizers or coalescing agents can be added to lower the temperature at which the film is formed. Alkali-soluble resins improve the ability of the aqueous coating composition to be stripped from the substrate before the application of a fresh coating. Waxes improve the gloss of the coating and allow the coating to be buffed. Biocides help minimize the formation of molds or mildew in the coating. Antifoamers and defoamers minimize the formation of bubbles in the coating.

Suitable polyvalent metals include beryllium, cadmium, copper, calcium, magnesium, zinc, zirconium, barium, strontium, aluminum, bismuth, antimony, lead, cobalt, iron, nickel, and the like. Although the polyvalent metal compound can be added to the aqueous coating composition in dry form such as powder, it is preferably added as a solution. The polyvalent metal compound is typically a metal complex, a metal salt of an organic acid, or a metal chelate. The ammonia and amine complexes of these metals are particularly useful because of their high solubility. Amines capable of complexing many metals include, for example, monoethanol amine, diethylaminoethanol, and ethylenediamine. Polyvalent metal complexes and salts of organic acids are typically soluble in an alkaline pH range. Anions of organic acids include acetate, formate, carbonate, glycolate, octanoate, benzoate, bluconate, oxalate, lactate, and the like. Polyvalent metal chelates where the ligand is a bidentate amino acid such as glycine or alanine can also be used.

Zinc and cadmium are preferred polyvalent metal ions. Preferred polyvalent metal compounds include zinc acetate, cadmium acetate, zinc glycinate, cadmium glycinate, zinc carbonate, cadmium carbonate, zinc benzoate, zinc salicylate, zinc glycolate, and cadmium glycolate. In some applications, a fugitive ligand such as ammonia is preferred. A ligand is considered fugitive if at least a portion of the ligand tends to volatilize as the coating dries to form a film on the substrate.

The alkali-soluble resins include copolymers of styrene or vinyl toluene with at least one alpha-beta-monoethylenically unsaturated acid or anhydride such as styrene-maleic anhydride resins, rosin/maleic anhydride adducts which are condensed with polyols, and the like. The alkali-soluble resins typically have a weight average molecular weight from about 500 to 10,000 and or from about 1000 to 5000. The resins are often used as a conventional resin cut, which is an aqueous solution of the resin with an alkaline substance having a fugitive cation such as ammonium hydroxide. The alkali soluble resin is typically used in amounts from 0 to about 20 weight percent or in amounts from 0 to about 15 weight percent based on the weight of the aqueous coating composition.

The waxes or mixtures of waxes that can be used include waxes of a vegetable, animal, synthetic, and/or mineral origin. Representative waxes include, for example, carnuba, candelilla, lanolin, stearin, beeswax, oxidized polyethylene wax, polyethylene emulsions, polypropylene, copolymers of ethylene and acrylic esters, hydrogenated coconut oil or soybean oil, and the mineral waxes such as paraffin or ceresin. The waxes typically range from 0 to about 15 weight percent or from about 2 to about 10 weight percent based on the weight of the aqueous coating composition.

The aqueous coating composition may contain from about 1 to about 10 weight percent plasticizer based on the weight of the aqueous coating composition. The plasticizer facilitates film formation at ambient temperatures when the coating is applied to a substrate. A fugitive or semi-fugitive plasticizer is preferred over a permanent plasticizer for many applications. A fugitive or semi-fugitive plasticizer is a plasticizer that at least partially evaporates as the coating dries. Permanent plasticizers do not evaporate. Mixtures of fugitive and permanent plasticizers can be used. The particular plasticizer and the amount used are chosen in accordance with the demand for compatibility with the formulation, efficiency in lowering the film-forming temperature, and clarity of the coating.

Fugitive plasticizers or coalescents include, for example, the monobutyl, monoethyl, monomethyl or other monoalkyl ethers of diethylene glycol or diproplyleneglycol, isophorone, benzyl alcohol, butyl cellosolve, and 3-methoxybutanol-1. Permanent plasticizers include, for example, benzyl butyl phthalate, dibutyl phthalate, dimethyl phthalate, triphenyl phosphate, 2-ethyl hexyl benzylphthalate, fatty oil acid esters of caprolactam, acetyl tributyl citrate, toluene ethyl sulfonamide, tributoxyethyl phosphate, and tributyl phosphate.

In some embodiments, it may be desirable to add particles to the aqueous coating composition. The particles may be inorganic or fluorinated particles. Examples of inorganic particles include metal oxide particles that may or may not be surface modified. In some embodiments, the surface-modified, inorganic particle material comprises a plurality of ceramic-type particles modified by a coupling agent such as an alkyl silane. Examples of useful metal oxides include silica, alumina, zirconia, vanadia, titania, ceria, iron oxide, antimony oxide, tin oxide, alumina/silica and combinations thereof, with silica being the most preferred. Regardless of the exact material employed, the inorganic particles are preferably nanoparticles having an average particle size (diameter) of 5-150 nanometers. Nanoparticles do not significantly impair the transparency of the coated composition after drying and are therefore preferred. Examples of fluorinated particles include PTFE (polytetrafluoroethylene) particles. Such particles are commercially available as dispersions in water allowing for easy inclusion in aqueous coating compositions. Examples of useful particle dispersions include DYNEON TF 5032 from Dyneon; nanoFLON W 50C, FLUORO AQ-50, HYDROCERF 9174 from Shamrock and LANCO GLIDD 3993 or LANCO GLIDD 6940 from Noveon. In addition the PTFE dispersion may contain waxes or other additives such as HYDROCER 6099 available from Shamrock which contains low molecular weight polyethylene wax.

The aqueous coating compositions may be prepared in a variety of ways. In some embodiments, the film-forming polymer is an aqueous film-forming composition. The aqueous film forming polymer composition may be in the form of a polymer suspension, emulsion or dispersion that may be pre-made or commercially purchased. Examples of suitable pre-made emulsions which are aqueous film-forming polymer compositions, include for example DURAPLUS 2 and DURAPLUS 3 commercially available from Rohm and Haas, Philadelphia, Pa., MEGATRON 240 commercially available from Interpolymer, Canton, Mass. or MOR-GLO-2 commercially available from OMNOVA Solutions, Chester, S.C. These pre-made aqueous polymer systems may contain other additives besides the film-forming polymer, but generally they are free or essentially free of fluorochemical and silicon-containing materials. The hydrocarbon-based surfactants and any other desired additives may be mixed with the pre-made polymer suspension, emulsion or dispersion. The aqueous coating compositions thus formed may also be diluted with water or water miscible solvents such as alcohols. In other embodiments the film-forming polymer may be prepared in the presence of the hydrocarbon-based surfactants.

The aqueous coating compositions typically have a solids content from about 10 to about 50 weight percent. In one embodiment, the solids range from about 10 to about 30 weight percent. In other embodiments the solids range from about 15 to about 25 weight percent based on the weight of the aqueous coating composition. In yet another embodiment, a concentrated aqueous coating composition is provided containing up to about 35 to about 50 weight percent solids based on the weight of the aqueous coating composition. Such concentrated compositions are generally diluted prior to use by either mixing the concentrate with water or by applying the aqueous coating composition with a wet mop or applicator.

The pH of the aqueous coating composition is typically in the range of about 6 to about 10.5. In other embodiments, the pH is between about 7.5 and about 9.9. The pH can be adjusted using various bases or buffering agents. Suitable bases or buffering agents include, for example, borax, sodium hydroxide, alkali phosphates, alkali silicates, alkali carbonates, ammonia, and amines such as diethanolamine or triethanolamine.

In some embodiments it is desirable to add a non-fluorinated, silicone-free defoamer to the aqueous coating composition. Examples of such defoamers include hydrocarbon based defoamers such as SURFYNOL MD-20 commercially available from Air Products and Chemicals, Allentown, Pa. In other embodiments it may be desirable to add a defoamer that contains silicone such as SE-21 commercially available from Wacker Chemical Corporation.

Another aspect of the present disclosure provides a method for applying the aqueous coating compositions to surfaces. The compositions may be applied with a mop, sponge, roller, cloth, brush, pad or any other suitable tools such at T-bar applicators, application dispensing tools or spray application equipment. The compositions can be applied to a variety of substrates including floor, wall, furniture, window, counter top and bathroom surfaces. The substrates can be fibers, metal, plastic, wood, stone, brick, glass, cement, concrete, ceramic, masonite, dry wall, plaster, plastic, and the like. Bathroom surfaces can be countertops, shower stalls, toilets, and urinals. In one embodiment, the substrate is a floor surface. The floor surface can be wood, composite vinyl tile, vinyl, linoleum, asphalt, asbestos, concrete, ceramic, and the like.

Typically after the aqueous coating composition is applied to a surface it is permitted to dry to form a surface with a coating. The coating may comprise a single layer or multiple layers. Multiple layers may be achieved be applying multiple coatings of the aqueous coating composition. The multiple coatings may be applied immediately or after the coating has dried. In some embodiments, the coating comprises 2, 3, 4 or more layers. Each coat may be applied in the same way or different techniques may be used to apply each coat.

### EXAMPLES

These examples are for illustrative purposes only and are not meant to limit the scope of the claims. All parts, percentages, ratios, etc. in the examples and the rest of the specification are by weight, unless noted otherwise. Solvents and other reagents used were obtained from Sigma-Aldrich Chemical Company; Milwaukee, Wis. unless otherwise noted.

Table of Abbreviations

| Abbreviation or | |
|---|---|
| Trade Designation | Description |
| SURFYNOL 504 | A non-silicone, solvent-free, acetylenic diol-based wetting agent |
| | commercially available from Air Products and Chemicals, |
| | Allentown, PA. |
| DYNOL 604 | An ethoxylated, acetylenic diol surfactant commercially available |
| | from Air Products and Chemicals, Allentown, PA. |
| SURFYNOL MD- | A 100% active, non-silicone defoamer commercially available from |
| 20 | Air Products and Chemicals, Allentown, PA. |
| DURAPLUS 2 | Modified acrylic floor finish polymer commercially available from |
| | Rohm and Haas, Philadelphia, PA |
| FC-129 | Fluorochemical wetting agent commercially available from 3M |
| | Company, St. Paul, MN |
| POLYFOX VM-1 | Fluorochemical wetting agent commercially available from |
| | OMNOVA Solutions, Chester, SC |
| SE 21 | Defoaming agent commercially available from Wacker Chemical |
| | Corporation, Adrian, MI |
| PRIMAL 1531 | Alkali soluble resin emulsion commercially available from Rohm |
| | and Haas, Philadelphia, PA |
| ME39235 | Wax emulusion commercially available from Michelman, |
| | Cincinnati, OH |
| DOWANOL | Slow evaporating glycol ether commercially available from Dow |
| Glycol Ether | Chemical, Midland, MI |
| KATHON CG/ICP | Broad spectrum microbicide commercially available from Rohm |
| | and Haas, Philadelphia, PA |
| KP-140 | low viscosity, trialkyl phosphate (plasticizer) commercially |
| | available from TCI |
| MEGATRAN 240 | Acrylic co-polymer commercially available from Interpolymer, |
| | Canton, MA |
| SYNTRAN 6160 | High density, oxidized polyethylene emulsion commercially |
| | available from Interpolymer, Canton, MA |
| SYNTRAN PA | Olefin/acrylate graft copolymer emulsion commercially available |
| 1465 | from Interpolymer, Canton, MA |
| SYNTRAN 3M 280 | Emulsion commercially available from Interpolymer, Canton, MA |
| AC 325 Emulsion | Calcium carbonate emulsion |
| MOR-GLO-2 | Acrylic floor finish polymer commercially available from |
| | OMNOVA Solutions, Chester, SC |
| CONREZ 30 | A styrene-acrylic copolymer commercially available from Morton |
| | Thiokol, Inc. |
| E43 | A non-ionic emulsion of maleated polypropylene wax from |
| | Eastman Chemical. |
| SURFYNOL 465 | A non-ionic surfactant commercially available from Air Products |
| | and Chemicals, Allentown, PA. |
| LANCO GLIDD | Aqueous dispersion of PTFE commercially available from Noveon, |
| 3993 | Inc., Cleveland, OH |
| FLUORO AQ-50 | Non-settling, PTFE dispersion commercially available from |
| | Shamrock Technologies, Inc., Newark, NJ |
| LANCO GLIDD | Aqueous dispersion of PTFE commercially available from Noveon, |
| 6940 | Inc., Cleveland, OH |
| NALCO 2327 | An aqueous dispersion (40% solids) of colloidal silica particles |
| | having an average particle diameter of 20 nanometers, |
| | commercially available from Nalco Chemical Company, |
| | Naperville, IL |
| PTFE | Polytetrafluoroethylene |

### Test Methods

### Gloss Measurement

For gloss measurements, the test method ASTM D1455 was followed. Measurements of 20 and 60 degree gloss were made with a Micro Tri Gloss reader (BYK Gardner, Germany) on the substrates and coatings described for each example.

### Recoatability Testing

Recoatability was tested following test method ASTM D3153. Four coats of a test coating composition were applied to a black vinyl composite tile (VCT), one coat every 15, 30, or 60 minutes. 20 and 60 degree gloss was measured after each coat.

### Removability

Removability was tested according to the test method ASTM D1792 on black vinyl composite tile (VCT).

### Detergent Resistance Test

Detergent resistance was tested according to the test method ADTM D3207 on white vinyl composite tile (VCT).

### Soil Resistance Test

Soil resistance was tested according to the test method ADTM D3206 on white vinyl composite tile (VCT).

### Visual Appearance Tests.

A series of visually scored tests were performed on test finishes. A cumulative score for each test finish was assigned from the scores of each individual test for each of the three test formulations. The tests and scoring profiles are described below.

Leveling.:

A 1 milliliter quantity of test polish is applied and spread over one quarter of a black vinyl composite tile (VCT). Immediately after spreading, an “X” is placed in the wet polish by drawing the applicator diagonally corner to corner. After drying, leveling was rated based on the following scale:

4—No X perceptible.
3—Faint outline of X, no ridges in film.
2—Plain outline of X, no ridges in film.
1—Plain outline of X with ridges in film.

### Black Mark Resistance: (as Described in CSMA Bulletin No. 9-73)

One half of a white VCT was coated with 2 milliliters of TopLine Floor Finish, commercially available from 3M Company, St. Paul, Minn. (used as a control) and the other half with a test finish. The test finish was scored compared to the control.

3—Better black mark resistance than control.
2—Equivalent black bark resistance with control.
1—Worse black mark resistance than control.

### Water Resistance: (as Described in the Test Method ASTM D1793)

One milliliter of tap water was dropped on top of the test finish and scored for damage to the finish.

5—No water mark or perceptible damage to finish.
4—Faint water outline.
3—Slight film whitening.
2—Film whitening with some blistering and lifting.
1—Complete film failure.

### SYNTHESIS EXAMPLES

Three base formulations were prepared and used to prepare example aqueous coating compositions.

### Base Formulation 1:

The reagents shown in Table BF-1 and were mixed together to form Base Formulation 1.

TABLE BF-1

| | Amount |
|---|---|
| Reagent Description | (weight %) |
| Deionized Water | 32.645 |
| DOWANOL Glycol | 5.940 |
| Ether | |
| SE-21 | 0.016 |
| KATHON CG/ICP | 0.023 |
| KP-140 | 3.131 |
| MEGATRAN 240 | 54.976 |
| SYNTRAN 6160 | 1.381 |
| SYNTRAN PA 1465 | 1.427 |

### Base Formulation 2:

The reagents shown in Table BF-2 and were mixed together to form Base Formulation 2.

TABLE BF-2

| | Amount |
|---|---|
| Reagent Description | (weight %) |
| Deionized Water | 32.645 |
| DOWANOL Glycol | 5.940 |
| Ether | |
| SE-21 | 0.016 |
| KATHON CG/ICP | 0.023 |
| KP-140 | 3.131 |
| DURAPLUS 2 | 54.976 |
| SYNTRAN 6160 | 1.381 |
| SYNTRAN PA 1465 | 1.427 |

### Base Formulation 3:

The reagents shown in Table BF-3 and were mixed together to form Base Formulation 3.

TABLE BF-3

| | Amount |
|---|---|
| Reagent Description | (weight %) |
| Deionized Water | 49.231 |
| SE-21 | 0.016 |
| KATHON CG/ICP | 0.023 |
| Ethyl Carbitol | 6.000 |
| KP-140 | 1.710 |
| MOR-GLO-2 | 29.660 |
| SYNTRAN 3M 280 | 8.210 |
| CONREZ 30 | 1.090 |
| AC 325 Emulsion | 1.440 |
| E43 | 1.370 |

### Example 1 and Comparative Examples C1 and C2

In a vessel the compounds shown in Table 1 were mixed. The thus formed aqueous coating compositions were tested for Gloss using the test method listed above on black vinyl composite tile (VCT), these data are presented in Table 2.

TABLE 1

| | | Amount in | Amount in |
|---|---|---|---|
| | Amount in | Comparative | Comparative |
| | Comparative | Example | Example 1 |
| Reagent | Example C1 (wt %) | C2 (wt %) | (wt %) |
| FC-129 | 0.009 | — | — |
| POLYFOX VM-1 | — | 0.05 | — |
| SE 21 | 0.02 | 0.015 | — |
| SURFYNOL 504 | — | — | 0.10 |
| DYNOL 604 | — | — | 0.05 |
| SURFYNOL MD-20 | — | — | 0.20 |
| Dipropylene glycol | 5.56 | 5.56 | 5.56 |
| methyl ether | | | |
| Dibutyl phthalate | 1.08 | 1.08 | 1.08 |
| Tributoxy ethyl | 1.28 | 1.28 | 1.28 |
| phosphate | | | |
| DURAPLUS 2 | 38.09 | 38.09 | 38.09 |
| PRIMAL 1531 | 1.92 | 1.92 | 1.92 |
| ME39235 | 3.12 | 3.12 | 3.12 |
| Deionized Water | 48.921 | 48.885 | 48.60 |

TABLE 2

| Example | Gloss 20° | Gloss 60° |
|---|---|---|
| Comparative Example C1 | 1.75 | 15.4 |
| with 0 coats | | |
| Comparative Example C1 | 8.05 | 42.5 |
| with 1coat | | |
| Comparative Example C1 | 19.85 | 65.8 |
| with 2 coats | | |
| Comparative Example C1 | 36.75 | 79.4 |
| with 3 coats | | |
| Comparative Example C1 | 47.0 | 82.6 |
| with 4 coats | | |
| Comparative Example C2 | 1.7 | 15.6 |
| with 0 coats | | |
| Comparative Example C2 | 8.0 | 43.0 |
| with 1 coat | | |
| Comparative Example C2 | 20.55 | 66.6 |
| with 2 coats | | |
| Comparative Example C2 | 39.3 | 80.25 |
| with 3 coats | | |
| Comparative Example C2 | 51.75 | 83.6 |
| with 4 coats | | |
| Example 1 with 0 coats | 1.8 | 15.8 |
| Example 1 with 1 coat | 8.3 | 43.3 |
| Example 1 with 2 coats | 26.1 | 72.0 |
| Example 1 with 3 coats | 45.3 | 83.1 |
| Example 1 with 4 coats | 58.45 | 86.5 |

### Examples 2-7 and Comparative Example C3

For Examples 2-7 and Comparative Example C3 Base Formulations 1-3 were used and surfactant and in some instances particles were added to generate an example aqueous coating composition.

### Example 2

Three test formulations were prepared (2A, 2B and 2C) as shown in Table 3 by adding the listed reagents to the listed Base Formulation. Some of the example formulations were tested for Recoatability, Gloss, and the Visual Appearance Tests according to the test methods listed above. Data for Recoatability are presented in Table 10, data for Gloss on white tiles are presented in Table 11, data for Gloss on black tiles are presented in Table 12 and data for the Visual Appearance Tests are presented in Table 13. In addition, all of the example formulations were tested for Removability, Detergent Resistance and Soil Resistance according to the test methods listed above and all test formulations performed to an acceptable standard on these tests when compared to a control formulation of TopLine Floor Coating (Comparative Example C4).

TABLE 3

| | | | | Amount of |
|---|---|---|---|---|
| | | Amount of | Amount of | LANCO |
| | Base | SURFYNOL | DYNOL 604 | GLIDD 3993 |
| | Formulation | 465 Added | Added | added |
| Example | Used | (weight %) | (weight %) | (weight %) |
| 2A | 1 | 0.25 | 0.25 | 2 |
| 2B | 2 | 0.25 | 0.25 | 2 |
| 2C | 3 | 0.25 | 0.25 | 2 |

### Example 3

Three test formulations were prepared (3A, 3B and 3C) as shown in Table 4 by adding the listed reagents to the listed Base Formulation. Some of the example formulations were tested for Recoatability, Gloss, and the Visual Appearance Tests according to the test methods listed above. Data for Recoatability are presented in Table 10, data for Gloss on white tiles are presented in Table 11, data for Gloss on black tiles are presented in Table 12 and data for the Visual Appearance Tests are presented in Table 13. In addition, all of the example formulations were tested for Removability, Detergent Resistance and Soil Resistance according to the test methods listed above and all test formulations performed to an acceptable standard on these tests when compared to a control formulation of TopLine Floor Coating (Comparative Example C4).

TABLE 4

| | | Amount of | Amount of | Amount of |
|---|---|---|---|---|
| | Base | SURFYNOL | DYNOL 604 | FLUORO |
| | Formulation | 465 Added | Added | AQ-50 added |
| Example | Used | (weight %) | (weight %) | (weight %) |
| 3A | 1 | 0.25 | 0.25 | 1 |
| 3B | 2 | 0.25 | 0.25 | 1 |
| 3C | 3 | 0.25 | 0.25 | 1 |

### Example 4

Three test formulations were prepared (4A, 4B and 4C) as shown in Table 5 by adding the listed reagents to the listed Base Formulation. Some of the example formulations were tested for Recoatability, Gloss, and the Visual Appearance Tests according to the test methods listed above. Data for Recoatability are presented in Table 10, data for Gloss on white tiles are presented in Table 11, data for Gloss on black tiles are presented in Table 12 and data for the Visual Appearance Tests are presented in Table 13. In addition, all of the example formulations were tested for Removability, Detergent Resistance and Soil Resistance according to the test methods listed above and all test formulations performed to an acceptable standard on these tests when compared to a control formulation of TopLine Floor Coating (Comparative Example C4).

TABLE 5

| | | | | Amount of |
|---|---|---|---|---|
| | | Amount of | Amount of | LANCO |
| | Base | SURFYNOL | DYNOL 604 | GLIDD 6940 |
| | Formulation | 465 Added | Added | added |
| Example | Used | (weight %) | (weight %) | (weight %) |
| 4A | 1 | 0.25 | 0.25 | 2 |
| 4B | 2 | 0.25 | 0.25 | 2 |
| 4C | 3 | 0.25 | 0.25 | 2 |

### Example 5

Three test formulations were prepared (5A, 5B and 5C) as shown in Table 6 by adding the listed reagents to the listed Base Formulation. Some of the example formulations were tested for Recoatability, Gloss, and the Visual Appearance Tests according to the test methods listed above. Data for Recoatability are presented in Table 10, data for Gloss on white tiles are presented in Table 11, data for Gloss on black tiles are presented in Table 12 and data for the Visual Appearance Tests are presented in Table 13. In addition, all of the example formulations were tested for Removability, Detergent Resistance and Soil Resistance according to the test methods listed above and all test formulations performed to an acceptable standard on these tests when compared to a control formulation of TopLine Floor Coating (Comparative Example C4).

TABLE 6

| | | Amount of | Amount of | Amount of |
|---|---|---|---|---|
| | Base | SURFYNOL | DYNOL 604 | NALCO |
| | Formulation | 465 Added | Added | 2327 added |
| Example | Used | (weight %) | (weight %) | (weight %) |
| 5A | 1 | 0.25 | 0.25 | 1 |
| 5B | 2 | 0.25 | 0.25 | 1 |
| 5C | 3 | 0.25 | 0.25 | 1 |

### Example 6

Three test formulations were prepared (6A, 6B and 6C) as shown in Table 7 by adding the listed reagents to the listed Base Formulation. Some of the example formulations were tested for Recoatability, Gloss, and the Visual Appearance Tests according to the test methods listed above. Data for Recoatability are presented in Table 10, data for Gloss on white tiles are presented in Table 11, data for Gloss on black tiles are presented in Table 12 and data for the Visual Appearance Tests are presented in Table 13. In addition, all of the example formulations were tested for Removability, Detergent Resistance and Soil Resistance according to the test methods listed above and all test formulations performed to an acceptable standard on these tests when compared to a control formulation of TopLine Floor Coating (Comparative Example C4).

TABLE 7

| | | Amount of | Amount of |
|---|---|---|---|
| | Base | SURFYNOL | DYNOL 604 |
| | Formulation | 465 Added | Added |
| Example | Used | (weight %) | (weight %) |
| 6A | 1 | 0.25 | 0.25 |
| 6B | 2 | 0.25 | 0.25 |
| 6C | 3 | 0.25 | 0.25 |

### Example 7

Three test formulations were prepared (7A, 7B and 7C) as shown in Table 8 by adding the listed reagents to the listed Base Formulation. Some of the example formulations were tested for Recoatability, Gloss, and the Visual Appearance Tests according to the test methods listed above. Data for Recoatability are presented in Table 10, data for Gloss on white tiles are presented in Table 11, data for Gloss on black tiles are presented in Table 12 and data for the Visual Appearance Tests are presented in Table 13. In addition, all of the example formulations were tested for Removability, Detergent Resistance and Soil Resistance according to the test methods listed above and all test formulations performed to an acceptable standard on these tests when compared to a control formulation of TopLine Floor Coating (Comparative Example C4).

TABLE 8

| | | | | Amount of |
|---|---|---|---|---|
| | | Amount of | Amount of | SURFYNOL |
| | Base | SURFYNOL | DYNOL 604 | MD-20 |
| | Formulation | 465 Added | Added | added |
| Example | Used | (weight %) | (weight %) | (weight %) |
| 7A | 1 | 0.25 | 0.25 | 2 |
| 7B | 2 | 0.25 | 0.25 | 2 |
| 7C | 3 | 0.25 | 0.25 | 2 |

### Comparative Example C3

Three test formulations were prepared (C3A, C3B and C3C) as shown in Table 9 by adding a silicone surfactant to the listed Base Formulation. The Visual Appearance Tests were carried out according to the test methods listed above, and the data are presented in Table 13. In addition, all of the example formulations were tested for Removability, Detergent Resistance and Soil Resistance according to the test methods listed above and all test formulations performed to an acceptable standard on these tests when compared to a control formulation of TopLine Floor Coating (Comparative Example C4).

TABLE 9

| | | Amount of |
|---|---|---|
| | Base | SW-CP-K |
| | Formulation | Added |
| Example | Used | (weight %) |
| C3A | 1 | 0.50 |
| C3B | 2 | 0.50 |
| C3C | 3 | 0.50 |

### Comparative Example C4

The commercial product 3M TopLine Floor Coating (commercially available from 3M Company) was tested using the above listed test method for Gloss on white and black tiles according to the test method listed above, the date are presented in Tables 11 and 12. This coating was also used as the control for Removability, Detergent Resistance and Soil Resistance tests according to the test methods listed above.

TABLE 10
Recoatability Data

| | 20 degree | 20 degree | 20 degree | 60 degree | 60 degree | 60 degree |
|---|---|---|---|---|---|---|
| | gloss | gloss | gloss | gloss | gloss | gloss |
| | 15 minute | 30 minute | 60 minute | 15 minute | 30 minute | 60 minute |
| Example | recoat | recoat | recoat | recoat | recoat | recoat |
| 2A | 20 | 24 | 45 | 63 | 70 | 84 |
| 3A | 25 | 37 | 54 | 66 | 77 | 88 |
| 4A | 19 | 32 | 33 | 61 | 75 | 74 |
| 5A | 27 | 40 | 39 | 70 | 81 | 81 |
| 6A | 31 | 41 | 47 | 77 | 82 | 87 |
| 7A | 29 | 40 | 51 | 76 | 83 | 88 |

TABLE 11
Gloss on White Tiles

| | 20 | 20 | 20 | 20 | 60 | 60 | 60 | 60 |
|---|---|---|---|---|---|---|---|---|
| | degree | degree | degree | degree | degree | degree | degree | degree |
| | Gloss 1 | Gloss 2 | Gloss 3 | Gloss 4 | Gloss 1 | Gloss 2 | Gloss 3 | Gloss 4 |
| Example | Coat | Coats | Coats | Coats | Coat | Coats | Coats | Coats |
| C4 | 3.0 | 10.0 | 36.7 | 72.8 | 17.4 | 42.9 | 79.9 | 92.1 |
| 2A | 6.4 | 22.2 | 43.6 | 85.8 | 32.4 | 65.5 | 80.3 | 92.1 |
| 3A | 1.9 | 10.0 | 21.3 | 54.3 | 10.7 | 41.9 | 64.0 | 83.1 |
| 4A | 2.8 | 14.6 | 29.8 | 37.7 | 18.7 | 57.8 | 72.1 | 69.9 |
| 5A | 2.2 | 12.2 | 29.5 | 73.3 | 13.2 | 48.8 | 73.9 | 91.0 |
| 6A | 2.2 | 8.3 | 26.9 | 58.6 | 14.1 | 42.8 | 69.6 | 85.2 |
| 7A | 1.5 | 7.8 | 23.7 | 65.6 | 8.2 | 36.7 | 66.9 | 90.1 |

TABLE 12
Gloss on Black Tiles

| | 20 | 20 | 20 | 20 | 60 | 60 | 60 | 60 |
|---|---|---|---|---|---|---|---|---|
| | degree | degree | degree | degree | degree | degree | degree | degree |
| | Gloss 1 | Gloss 2 | Gloss 3 | Gloss 4 | Gloss 1 | Gloss 2 | Gloss 3 | Gloss 4 |
| Example | Coat | Coats | Coats | Coats | Coat | Coats | Coats | Coats |
| C4 | 13.0 | 32.0 | 44.0 | 41.0 | 42.0 | 68.0 | 79.0 | 80.0 |
| 2A | 11.0 | 26.0 | 40.0 | 36.0 | 38.0 | 66.0 | 80.0 | 78.0 |
| 3A | 10.0 | 19.0 | 35.0 | 38.0 | 36.0 | 58.0 | 76.0 | 74.0 |
| 4A | 7.0 | 16.0 | 29.0 | 33.0 | 31.0 | 53.0 | 73.0 | 73.0 |
| 5A | 13.0 | 23.0 | 37.0 | 34.0 | 42.0 | 60.0 | 79.0 | 78.0 |
| 6A | 10.0 | 23.0 | 39.0 | 35.0 | 36.0 | 63.0 | 80.0 | 78.0 |
| 7A | 11.0 | 19.0 | 37.0 | 30.0 | 41.0 | 58.0 | 78.0 | 78.0 |

TABLE 13
Visual Appearance Test Scores

| | Cumulative Visual Appearance Test Scores |
|---|---|
| | for Formulations Based on All 3 Base |
| Example | Formulations |
| 2 | 49 |
| 3 | 50 |
| 4 | 52 |
| 5 | 48 |
| 6 | 51 |
| 7 | 49 |
| C3 | 50 |

What is claimed is:

1. An aqueous coating composition comprising:
a film-forming polymer;
and at least two non-fluorinated and silicon-free hydrocarbon-based surfactants wherein the hydrocarbon-based surfactants are alkylated acetylenic diols.

2. The aqueous coating composition of claim 1 wherein the surfactants are non-ionic.

3. The aqueous coating composition of claim 1 wherein the surfactants are biodegradable.

4. The aqueous coating composition of claim 1 wherein the film-forming polymer is an acrylic, vinyl or vinyl/acrylic emulsion polymer or mixture thereof.

5. The aqueous coating composition of claim 4 wherein the vinyl/acrylic emulsion polymer is a styrene/acrylic emulsion polymer.

6. The aqueous coating composition of claim 1 wherein at least one of the alkylated acetylenic diols is an ethoxylated acetylenic diol.

7. The aqueous coating composition of claim 1 further comprising one or more additives selected from the group consisting of additional surfactants, polyvalent metal compounds, alkali soluble resins, waxes, permanent and fugitive plasticizers, defoamers, wetting agents, and biocides.

8. The aqueous coating composition of claim 1 further comprising a non-fluorinated defoamer.

9. The aqueous coating composition of claim 8 wherein the defoamer is a non-silicone defoamer.

10. A floor finish comprising the aqueous coating composition of claim 1.

11. A method for finishing a surface comprising:
applying to a surface an aqueous coating composition, the aqueous coating composition comprising a film-forming polymer and at least two non-fluorinated and silicon-free hydrocarbon-based surfactants wherein the hydrocarbon-based surfactants are alkylated acetylenic diols.

12. The method of claim 11 wherein the surface is a floor, wall, ceiling, countertop or bathroom surface.

13. A finished surface comprising a surface and a coating on the surface, the coating comprising an aqueous coating composition, the aqueous coating composition comprising a film-forming polymer and at least two non-fluorinated and silicon-free hydrocarbon-based surfactants, wherein the hydrocarbon-based surfactants are alkylated acetylenic diols.

14. The finished surface of claim 13 wherein the coating is dried.

15. The finished surface of claim 14 wherein the coating comprises multiple layers of the aqueous coating composition.

16. The finished surface of claim 15 wherein the surface is a black vinyl substrate, and the gloss at 20 degrees when measured using a gloss meter according to test method ASTM D1455 is at least 30.

17. The finished surface of claim 15 wherein the surface is a white vinyl substrate, and the gloss at 20 degrees when measured using a gloss meter according to test method ASTM D1455 is at least 37.

18. The aqueous coating composition of claim 1 further comprising inorganic particle material.

19. The aqueous coating composition of claim 1 further comprising fluorinated particle material.

20. A method for preparing an aqueous coating composition comprising:
providing an aqueous film-forming polymer composition; and
adding at least two non-fluorinated and silicon-free hydrocarbon-based surfactants wherein the hydrocarbon-based surfactants are alkylated acetylenic diols.
